(19) United States
(12) Patent Application Publication
(10) Pub. No.: US 2012/0166682 A1
(43) Pub. Date: Jun. 28, 2012

(54) MEMORY MAPPING APPARATUS AND MULTIPROCESSOR SYSTEM ON CHIP PLATFORM INCLUDING THE SAME

(75) Inventors: June Young CHANG, Daejeon (KR); Nak Woong Eum, Daejeon (KR)

(73) Assignee: ELECTRONICS AND TELECOMMUNICATIONS RESEARCH INSTITUTE, Daejeon (KR)

(21) Appl. No.: 13/307,021

(22) Filed: Nov. 30, 2011

(30) Foreign Application Priority Data
Dec. 23, 2010 (KR) 10-2010-0134045

(51) Int. Cl. G06F 13/28

(52) U.S. Cl. 710/22

(57) ABSTRACT

A memory mapping apparatus includes a core/memory selector adapted to select a core from among a plurality of cores, and select a memory from among a plurality of memories, a transfer path allocator adapted to allocate a data transfer path between the core and memory which are selected by the core/memory selector, and a DMA control signal setter adapted to set a signal to be controlled to a DMA Controller which controls a plurality of DMAs corresponding to data transfer paths between the cores and the memories.

### CROSS-REFERENCE TO RELATED APPLICATIONS

The present application claims priority to Korean patent application number 10-2010-0134045, filed on Dec. 23, 2010, which is incorporated by reference in its entirety.

### BACKGROUND OF THE INVENTION

The present invention relates to a memory mapping apparatus, and more particularly, to a memory mapping apparatus and a multiprocessor System On Chip (SOC) platform including the same, which enable high-speed efficient data transfer.

Generally, data is transferred between a master and a slave. Herein, the master, i.e., a core may be a processor, and the slave may be a memory. The core such as the processor performs an operation, and the slave such as the memory store the operation result.

Recently, research is being done on a system including a plurality of masters and slaves. The system including the plurality of masters and slaves increases a data processing speed through multitasking.

In a conventional system including a plurality of conventional masters and slaves, however, although multitasking is made, entire system efficiency is reduced because data are not smoothly transferred between the masters and the slaves.

The technical configuration described above is provided to aid in understanding the present invention, and does not denote widely-known technology in the related art to which the present invention pertains.

### SUMMARY OF THE INVENTION

Embodiments of the present invention are directed to a memory mapping apparatus and a multiprocessor system on chip platform including the same, which generate a platform where various types of memory structures are reconfigured and remove a delay time between a core and a memory, thereby enhancing entire performance of a system.

In one embodiment, a memory mapping apparatus includes: a core/memory selector adapted to select a core from among a plurality of cores, and select a memory from among a plurality of memories; a transfer path allocator adapted to allocate a data transfer path between the core and memory which are selected by the core/memory selector; and a Direct Memory Access (DMA) control signal setter adapted to set a signal to be controlled to a DMA Controller (DMAC) which controls a plurality of DMAs corresponding to data transfer paths between the cores and the memories.

The transfer path allocator may set a data transfer path between a first core and a first memory, which have been respectively selected from among the cores and the memories by the core/memory selector, not to intersect a data transfer path, in which data transfer is being made, between a core other than the first core among the cores and a memory other than the first memory among the memories.

The DMA control signal setter may set a signal to be transferred to the DMAC through the data transfer path which is set by the transfer path allocator.

In another embodiment, a multiprocessor System On Chip (SOC) platform include: a plurality of cores; a plurality of memories; a plurality of Direct Memory Accesses (DMAs) adapted to be data transfer paths between the cores and the memories; and a memory mapping apparatus adapted to include a core/memory selector which selects a core and a memory corresponding to the core from among the cores and the memories, a DMA control signal setter which sets a signal to be controlled to a DMA Controller (DMAC) for controlling the DMAs, and a transfer path allocator which allocates a data transfer path between the core and memory selected by the core/memory selector.

The transfer path allocator may set a data transfer path between a first core and a first memory, which have been respectively selected from among the cores and the memories by the core/memory selector, not to intersect a data transfer path, in which data transfer is being made, between a core other than the first core among the cores and a memory other than the first memory among the memories.

The DMA control signal setter may set a signal to be transferred to the DMAC through the data transfer path which is set by the transfer path allocator.

The cores may decode data simultaneously, the decoded data may be simultaneously stored in the memories, and the transfer path allocator may set data transfer paths between the cores and the memories not to intersect therebetween.

### BRIEF DESCRIPTION OF THE DRAWINGS

FIG. 1 illustrates a block diagram of a memory mapping apparatus according to a first embodiment of the present invention.

FIG. 2 illustrates a block diagram of a memory mapping apparatus according to a second embodiment of the present invention.

FIG. 3 illustrates a block diagram of a multiprocessor SOC platform according to a third embodiment of the present invention.

FIG. 4 illustrates a schematic block diagram of a system according to a comparison example of the present invention.

### DESCRIPTION OF SPECIFIC EMBODIMENTS

Hereinafter, a memory mapping apparatus and a multiprocessor system on chip platform including the same in accordance with the present invention will be described in detail with reference to the accompanying drawings.

In the drawings, the thicknesses of lines or the sizes of elements may be exaggeratedly illustrated for clarity and convenience of description. Moreover, the terms used henceforth have been defined in consideration of the functions of the present invention, and may be altered according to the intent of a user or operator, or conventional practice. Therefore, the terms should be defined on the basis of the entire content of this specification.

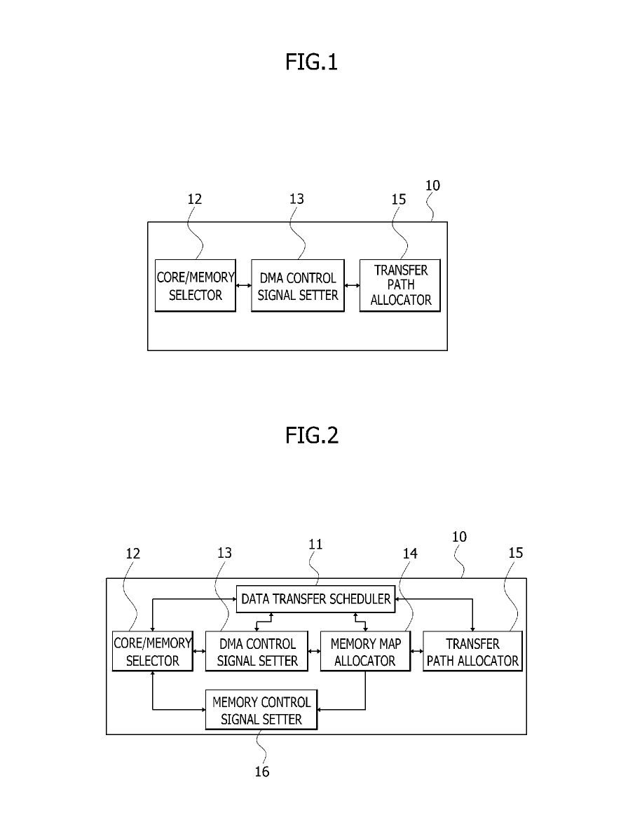

FIG. 1 illustrates a block diagram of a memory mapping apparatus according to a first embodiment of the present invention.

Referring to FIG. 1, a memory mapping apparatus 10 according to a first embodiment of the present invention includes a core/memory selector 12, a transfer path allocator 15, and a Direct Memory Access (DMA) control signal setter 13.

The memory mapping apparatus 10 is included in a multiprocessor System On Chip (SOC) platform that includes a plurality of cores, a plurality of memories, and a plurality of DMAs that are transfer paths between the cores and the memories. The memory mapping apparatus 10 controls data transfer between the cores and the memories.

The core/memory selector 12 selects a core and a memory from among the cores and the memories, respectively.

The transfer path allocator 15 allocates a data transfer path between the core and memory that have been selected by the core/memory selector 12. The transfer path allocator 15 sets a data transfer path between a first core of the cores selected by the core/memory selector 12 and a first memory of the memories selected by the core/memory selector 12, wherein the data transfer path does not intersect a data transfer path between a core different from the first core and a memory different from the first memory, in which data transfer is being made.

Through this, data are smoothly transferred between the cores and the memories when the cores perform multitasking, and thus entire system efficiency can increase considerably.

The DMA control signal setter 13 sets a signal to be transferred to a DMA controller that controls DMA according to the data transfer path set by the transfer path allocator 15.

Since the transfer path allocator 15 allocates the optimal path between a selected core and memory, the memory mapping apparatus 10 enables efficient data transfer between a plurality of necessary cores and memories when the cores perform multitasking. Detailed description on this will be made below.

The memory mapping apparatus 10 is not limited to the configuration of FIG. 1, and the technical scope of the present invention may further include other elements.

FIG. 2 illustrates a block diagram of a memory mapping apparatus according to a second embodiment of the present invention.

Referring to FIG. 2, a memory mapping apparatus 10 according to a second embodiment of the present invention further includes a data transfer scheduler 11, a memory map allocator 14, and a memory control signal setter 16.

The memory map allocator 14 determines a memory map for storing data. The memory control signal setter 16 sets a control signal applied to a memory, according to a memory map determined by the memory map allocator 14.

The core/memory selector 12, the transfer path allocator 15, the DMA control signal setter 13, the memory map allocator 14 and the memory control signal setter 16 communicate with the data transfer scheduler 11 that serves as a Central Processing Unit (CPU). Herein, the transfer path allocator 15 allocates the optimal path between a core and a memory, and thus, when a plurality of cores perform multitasking, data may be efficiently transferred between necessary cores and memories. This will be described below.

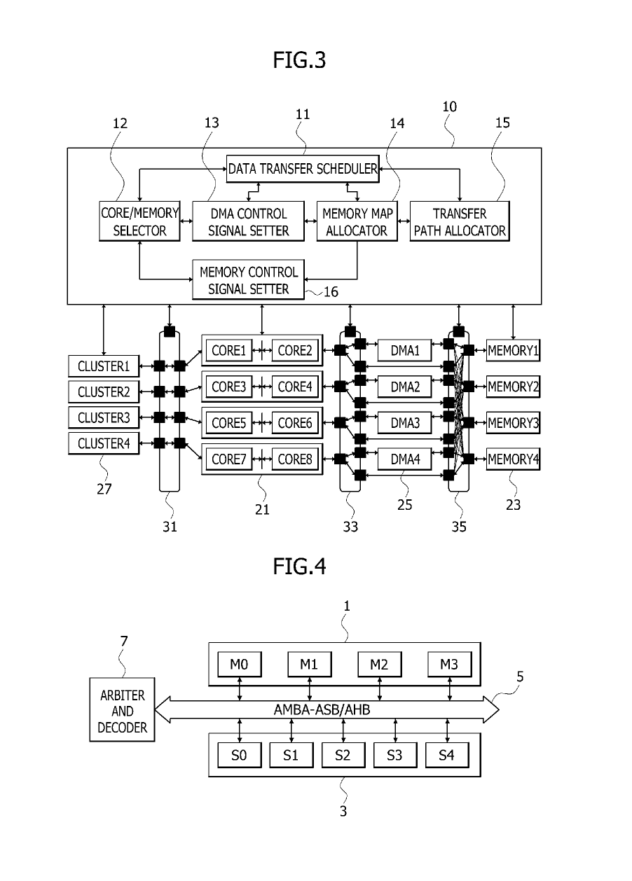

FIG. 3 illustrates a block diagram of a multiprocessor SOC platform according to a third embodiment of the present invention.

A multiprocessor SOC platform according to a third embodiment of the present invention includes the memory mapping apparatus 10 according to the second embodiment of the present invention.

The multiprocessor SOC platform according to the third embodiment of the present invention includes a plurality of cores 21, a plurality of memories 23, a plurality of DMAs 25 that are data transfer paths between the cores 21 and the memories 23, and a memory mapping apparatus 10. The cores 21, for example, may be multimedia cores.

The memory mapping apparatus 10 includes a core/memory selector 12, a transfer path allocator 15, and a DMA control signal setter 13.

The core/memory selector 12 selects a core from among the cores, and selects a memory corresponding to the selected core from among the memories.

The transfer path allocator 15 allocates a data transfer path between the core and memory that have been selected by the core/memory selector 12. The transfer path allocator 15 sets a data transfer path between a first core (core 1) of the cores 21 selected by the core/memory selector 12 and a first memory (memory 1) of the memories 23 selected by the core/memory selector 12, wherein the data transfer path does not intersect a data transfer path between a core different from the first core (core 1) and a memory different from the first memory (memory 1), in which data transfer is being made.

Through this, data are smoothly transferred between the cores 21 and the memories 23 when the cores 21 perform multitasking, and thus entire system efficiency can increase considerably.

The DMA control signal setter 13 sets a signal to be transferred to a DMA controller that controls DMA according to the data transfer path set by the transfer path allocator 15.

Since the transfer path allocator 15 of the memory mapping apparatus 10 allocates the optimal path between a selected core and memory, the multiprocessor SOC platform according to the third embodiment of the present invention enables efficient data transfer between a plurality of necessary cores and memories when the cores perform multitasking.

The memory mapping apparatus 10 of the multiprocessor SOC platform according to the third embodiment of the present invention, as illustrated in FIG. 3, may further include elements. For example, the memory mapping apparatus 10 may further include a data transfer scheduler 11, a memory map allocator 14, and a memory control signal setter 16.

The memory map allocator 14 determines a memory map for storing data. The memory control signal setter 16 sets a control signal applied to a memory, according to a memory map determined by the memory map allocator 14.

The core/memory selector 12, the transfer path allocator 15, the DMA control signal setter 13, the memory map allocator 14 and the memory control signal setter 16 communicate with the data transfer scheduler 11 that serves as a CPU. The transfer path allocator 15 allocates the optimal path between a core and a memory, and thus, when a plurality of cores perform multitasking, data may be efficiently transferred between necessary cores and memories.

In the multiprocessor SOC platform, the cores 21 simultaneously decode data, and the decoded data are simultaneously stored in the memories 23. The transfer path allocator 15 sets data transfer paths between the cores 21 and the memories 23 in order for the data transfer paths therebetween not to be intersected with each other.

For example, the memory 1 is a flash memory and stores data and a program to be executed by the core 1.

The memory mapping apparatus 10 reads the program and data that are stored in the memory 1 being the flash memory, and stores the read program and data in a Static Read Only Memory (SROM)/Static Random Access Memory (SRAM) being a memory 2. The program and data are stored in the memory 2, and the core 1 executes the program.

Subsequently, the memory mapping apparatus 10 allows eight cores (for example, core 1 to core 8) to execute H.264 decoder software simultaneously.

Shared memory clusters 27 store intermediate calculation results that are obtained in the decoding operations of the cores. At this point, the memory map allocator 14 allocates which shared memory a specific intermediate calculation result is stored in, and sets a path through which the specific calculation result delivered via an SM switch 31 is stored in the shared memory.

The cores reads and decodes stream data stored in an SRAM, and stores the decoded data in a memory 3 that is Double Data Rate 1 (DDR1).

At this point, the DMA control signal setter 13 of the memory mapping apparatus 10 sets a DMA control signal and applies the signal to a DMAC. The DMA control signal setter 13 determines a Synchronous Dynamic Random Access Memory (SDRAM) and a DDR1 memory map. The memory control signal setter 16 sets a control signal of each memory controller. When data paths between the cores and memories are determined according to a transfer path allocated by the transfer path allocator 15, data are transferred through a DMA 25 by using the core switch 35 and the memory switch 35. In this case, data are simultaneously transferred between a plurality of cores and a plurality of memories even without overlapping.

FIG. 4 illustrates a schematic block diagram of a system according to a comparison example of the present invention. The system according to the comparison example of the present invention includes a plurality of masters 1, a plurality of slaves 3, and an arbiter and decoder 7. Herein, an ASB/AHB bus 5 connects the masters 1 and the slaves 3.

When a master MO exchanges data with a slave S3, other masters cannot exchange data with other slaves.

In the multiprocessor SOC platform 10 according to the third embodiment of the present invention, however, since the memory mapping apparatus 10 sets the data transfer path that is not preset but is changed depending on the case, the plurality of cores perform multiprocessing and exchange data with the plurality of memories.

The present invention can enhance system performance in the multi core platform including the memory mapping apparatus. Moreover, the present invention quickly designs the platform by using various types of cores and memory structures that are used in the multi core platform, and thus can be applied to various application fields.

While the present invention has been described with respect to the specific embodiments, it will be apparent to those skilled in the art that various changes and modifications may be made without departing from the spirit and scope of the invention as defined in the following claims.

What is claimed is:

1. A memory mapping apparatus comprising:
a core/memory selector adapted to select a core from among a plurality of cores, and select a memory from among a plurality of memories;
a transfer path allocator adapted to allocate a data transfer path between the core and memory which are selected by the core/memory selector; and
a Direct Memory Access (DMA) control signal setter adapted to set a signal to be controlled to a DMA Controller (DMAC) which controls a plurality of DMAs corresponding to data transfer paths between the cores and the memories.

2. The memory mapping apparatus of claim 1, wherein the transfer path allocator sets a data transfer path between a first core and a first memory, which have been respectively selected from among the cores and the memories by the core/memory selector, not to intersect a data transfer path, in which data transfer is being made, between a core other than the first core among the cores and a memory other than the first memory among the memories.

3. The memory mapping apparatus of claim 2, wherein the DMA control signal setter sets a signal to be transferred to the DMAC through the data transfer path which is set by the transfer path allocator.

4. A multiprocessor System On Chip (SOC) platform comprising:
a plurality of cores;
a plurality of memories;
a plurality of Direct Memory Accesses (DMAs) adapted to be data transfer paths between the cores and the memories; and
a memory mapping apparatus adapted to comprise a core/memory selector which selects a core and a memory corresponding to the core from among the cores and the memories, a DMA control signal setter which sets a signal to be controlled to a DMA Controller (DMAC) for controlling the DMAs, and a transfer path allocator which allocates a data transfer path between the core and memory selected by the core/memory selector.

5. The multiprocessor SOC platform of claim 4, wherein the transfer path allocator sets a data transfer path between a first core and a first memory, which have been respectively selected from among the cores and the memories by the core/memory selector, not to intersect a data transfer path, in which data transfer is being made, between a core other than the first core among the cores and a memory other than the first memory among the memories.

6. The multiprocessor SOC platform of claim 5, wherein the DMA control signal setter sets a signal to be transferred to the DMAC through the data transfer path which is set by the transfer path allocator.

7. The multiprocessor SOC platform of claim 4, wherein:
the cores decode data simultaneously,
the decoded data are simultaneously stored in the memories, and
the transfer path allocator sets data transfer paths between the cores and the memories not to intersect therebetween.
